(19) United States
(12) Patent Application Publication
(10) Pub. No.: US 2015/0040004 A1
(43) Pub. Date: Feb. 5, 2015

(54) DISPLAY CONTROL DEVICE, DISPLAY CONTROL METHOD, AND COMPUTER PROGRAM PRODUCT

(71) Applicant: KABUSHIKI KAISHA TOSHIBA, Tokyo (JP)

(72) Inventors: Tsukasa IKE, Tokyo (JP); Kazushige OUCHI, Saitama (JP); Yasunobu YAMAUCHI, Yokohama (JP)

(21) Appl. No.: 14/449,391

(22) Filed: Aug. 1, 2014

(30) Foreign Application Priority Data
Aug. 2, 2013 (JP) 2013-161326

(51) Int. Cl. G06F 17/21

(52) U.S. Cl. CPC G06F 17/212
USPC 715/253

(57) ABSTRACT

According to an embodiment, a display control device includes a selector and a controller. The selector is configured to acquire display condition information in which combinations of pieces of position-time information of a user and pieces of activity-time information are associated with pieces of display information to be displayed on a display device, respectively, specify a combination of a piece of position information and a piece of activity information associated with the time corresponding to the piece of position information, from among the combinations of the pieces of position information and the pieces of activity information in the display condition information, and select the piece of display information corresponding to the specified combination. The controller is configured to control to display the selected piece of display information on the display device.

### CROSS-REFERENCE TO RELATED APPLICATION

This application is based upon and claims the benefit of priority from Japanese Patent Application No. 2013-161326, filed on Aug. 2, 2013; the entire contents of which are incorporated herein by reference.

### FIELD

Embodiments described herein relate generally to a display control device, a display control method, and a computer program product.

### BACKGROUND

While going out for travel, shopping, or other occasions, you may have interest in more detailed information about a visited place, word of mouth about a restaurant that you happened to find, or detailed information on new merchandise found during shopping, for example. Recent proliferation of personal digital assistants such as smartphones can provide a certain amount of information on the spot even away from home. However, only limited information is usually obtained on the spot due to time constraints or other reasons.

After coming home, you may also look back and enjoy the things you experienced while you were out. For example, you may look back to the events experienced when you were out by looking at the photographs taken during the events, the brochures obtained during the events, or the like. However, even if you are interested on the spot in places of which photographs are forgotten to be taken, events or new merchandise happened to be encountered, or the like, you may forget them after coming home. A technique is known such as a device with which a user can check information relevant to the information encountered while the user is out, after coming home.

However, in conventional techniques, the user needs to specify information the user is interested in, in advance in a device, leading to cumbersome operation for displaying the information.

### BRIEF DESCRIPTION OF THE DRAWINGS

FIG. 1 is a block diagram illustrating an example of a display control device according to a first embodiment;

FIG. 2 is a diagram illustrating an example of the external view of the display of the first embodiment;

FIG. 3 is a table listing an example of position log information of the first embodiment;

FIG. 4 is a table listing an example of activity log information of the first embodiment;

FIG. 5 is a table listing an example of display condition information of the first embodiment;

FIG. 6 is a table listing an example of display candidate information of the first embodiment;

FIG. 7 is a diagram illustrating a display example on the display of the first embodiment;

FIG. 8 is a flowchart illustrating an example of a display control method of the first embodiment;

FIG. 9 is a block diagram illustrating an example of a display control device according to a second embodiment;

FIG. 10 is a table listing an example of display condition information of the second embodiment;

FIG. 11 is a table listing an example of priority change information of the second embodiment;

FIG. 12 is a flowchart illustrating an example of a display control method of the second embodiment; and

FIG. 13 is a block diagram illustrating an example of the main part of a hardware configuration of each of the display control devices of the first and the second embodiments.

### DETAILED DESCRIPTION

According to an embodiment, a display control device includes an acquisition unit, a selector, and a controller. The acquisition unit is configured to acquire position log information and activity log information, the position log information including pieces of position information that each indicate a position of a user and pieces of first time information that each indicate the time when the piece of position information is detected, the activity log information including pieces of activity information that each indicate activity of the user and pieces of second time information that each indicate the time when the corresponding piece of activity information is detected. The selector is configured to acquire display condition information in which combinations of the pieces of position information and the pieces of activity information are associated with pieces of display information to be displayed on a display device, respectively, specify a combination of a piece of position information included in the position log information and a piece of activity information associated with the time corresponding to the piece of position information in the activity log information, from among the combinations of the pieces of position information and the pieces of activity information in the display condition information, and select the piece of display information corresponding to the specified combination. The controller is configured to control to display the selected piece of display information on the display device.

Embodiments will be described below with reference to the accompanying drawings.

### First Embodiment

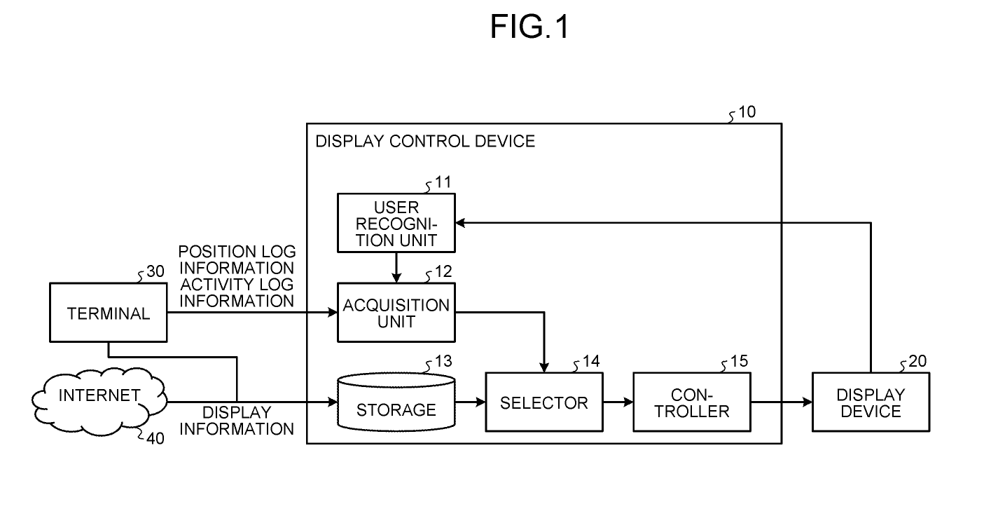

FIG. 1 is a block diagram illustrating an example of a display control device 10 according to a first embodiment. The display control device 10 is connected to a display device 20 through a network. The network may be wireless or wired. The display device 20 displays information (called “display information”, hereinafter). The display information includes various types of information such as photographs, tourist site information, merchandise information, and restaurant information. The display device 20 may also output audio together with the display information. The display control device 10 controls the display information to be displayed on the display device 20.

The display control device 10 includes a user recognition unit 11, an acquisition unit 12, a storage 13, a selector 14, and a controller 15. The user recognition unit 11 recognizes a user viewing the display information on the display device 20. A method for utilizing a camera will be described as an example of a method for recognizing the user by the user recognition unit 11.

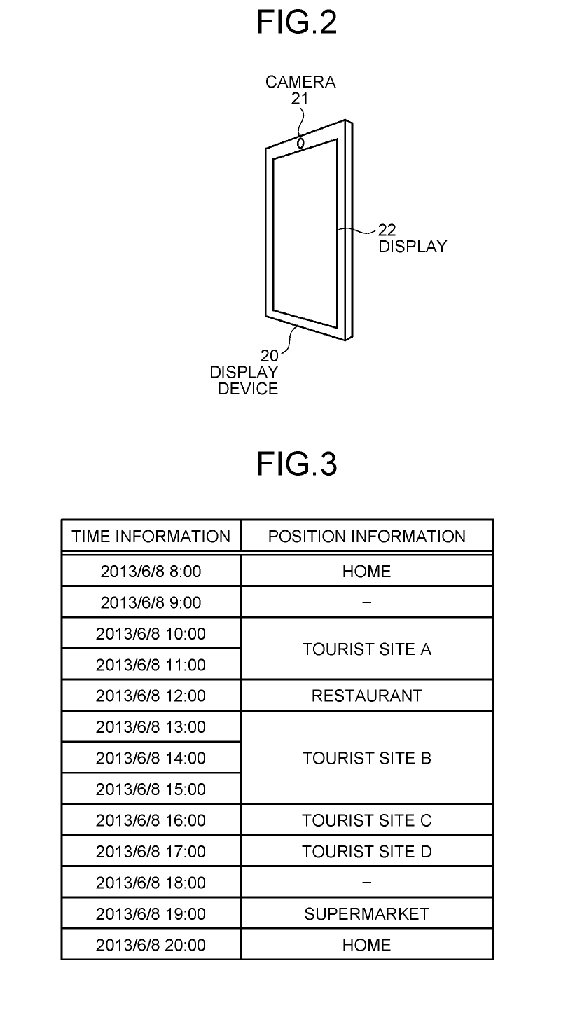

FIG. 2 is a diagram illustrating an example of the external view of the display device 20 of the first embodiment. The display device 20 includes a camera 21 and a display 22. The camera 21 takes static images or pictures of the surroundings of the display device 20. The display 22 is a screen displaying the display information. The display 22 is, for example, a display device such as a flat-panel display. The user recognition unit 11 receives the picture taken by the camera 21 and recognizes the face of a person in the picture to recognize the user. Specifically, the user recognition unit 11 recognizes the user by checking the face of the person in the picture against the face image of the user previously registered in the display control device 10. The detail of facial recognition technology with the camera 21 is already well known, and thus description thereof is omitted. The position of the camera 21 is not limited to the position in FIG. 2. A video camera independent of the display device 20 may also be disposed at a position from which the surrounding image of the display device 20 can be taken, for example.

Referring back to FIG. 1, a terminal 30 stores therein position log information and activity log information of the user.

The position log information will be described. FIG. 3 is a table listing an example of position log information of the first embodiment. The position log information includes position information indicating user positions and time information (corresponding to “first time information” of an aspect of the present invention) indicating times when the position information is detected. The position log information in FIG. 3 indicates the user position for every one hour. The acquisition frequency of the position information is not limited to every one hour and may be performed at any time interval. The position log information can be produced by, for example, utilizing global positioning system (GPS) function of the terminal 30 carried by the user. The position log information in FIG. 3 indicates, for example, that the user position at 14:00, Jun. 8, 2013 is a tourist site B.

The acquisition of the position information through the GPS is not limited to a method of utilizing the function of a personal digital assistant carried by the user. For example, the function of the GPS may also be integrated in an accessory such as a watch worn by the user. Furthermore, the acquisition of the position information is not limited to a method of utilizing the GPS. The position information of a user may also be acquired by, instead of utilizing the GPS, utilizing a known human detection technology or similar technologies to detect the user from images taken by cameras installed in public spaces, for example.

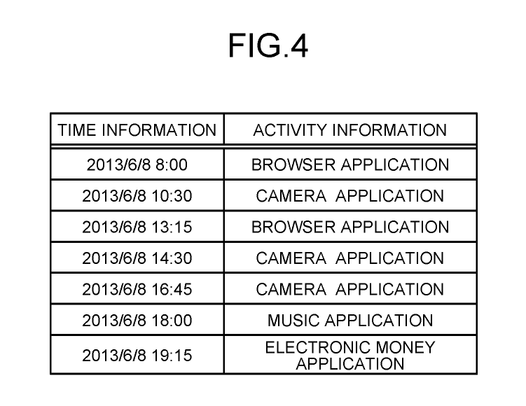

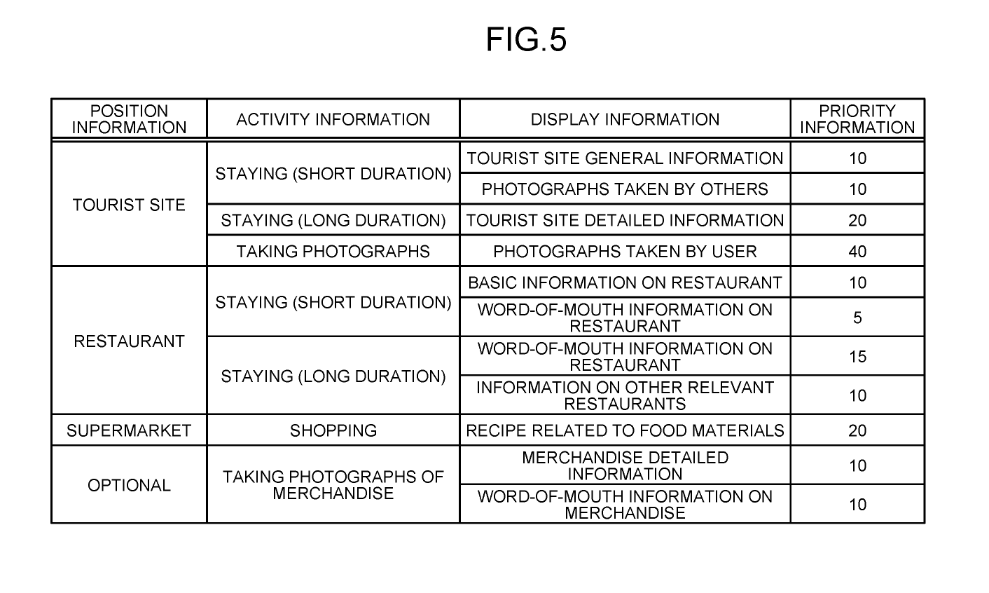

The activity log information is described. FIG. 4 is a table listing an example of activity log information of the first embodiment. The activity log information includes activity information indicating user activity and time information (corresponding to “second time information” of an aspect of the present invention) indicating times when the activity information is detected. The activity information in the present embodiment indicates applications executed by the user. The applications are installed in a personal digital assistant carried by the user. In other words, the display control device 10 of the present embodiment recognizes the activity log of the user by utilizing the execution log of applications in the terminal 30. The activity log information in FIG. 4 indicates, for example, that the user started an electronic money application at 19:15, Jun. 8, 2013. This allows the display control device 10 (the selector 14) to recognize that the user activity at 19:15, Jun. 8, 2013 was shopping.

Referring back to FIG. 1, the acquisition unit 12 acquires the position log information and the activity log information of the user recognized by the user recognition unit 11 from the terminal 30 of the user on the basis of user information previously registered in the display control device 10. The user information includes identification (ID or user ID) uniquely identifying the user, the face image of the user, and terminal information for connecting to the terminal 30 of the user. The terminal information is required for communication between the terminal 30 and the display control device 10. The terminal information includes an Internet Protocol (IP) address, a media access control (MAC) address, and a connection password of the terminal 30. Any communication method can be used between the terminal 30 and the display control device 10. The acquisition unit 12 acquires the position log information and the activity log information of the user from the terminal 30 of the user by utilizing the terminal information associated with the identification of the recognized user. The terminal 30 is, for example, a personal digital assistant such as a smartphone carried by the user when going out.

The acquisition unit 12 may also acquire the position log information and the activity log information, not from the terminal 30, but from a data server on the Internet 40, a home data storage device, or the like. For example, the position log information and the activity log information may be transmitted from the terminal 30 carried by the user to a data server on the Internet 40 whenever necessary. The acquisition unit 12 may also acquire the position log information and the activity log information from the data server.

The storage 13 stores therein information in the terminal 30 of the user, the Internet, and the like as display information. The selector 14 selects the display information to be displayed on the display device 20 from the storage 13 on the basis of the position information in the position log information and the activity information in the activity log information. The following describes display condition information used by the selector 14 to select the display information on the basis of the position information in the position log information and the activity information in the activity log information.

FIG. 5 is a table listing an example of display condition information of the first embodiment. The display condition information includes position information indicating positions, activity information indicating activity, and priority information indicating priority. This position information corresponds to the position information in the position log information. This activity information corresponds to the activity information in the activity log information. The display condition information is information in which combinations of the position information and the activity information are associated with the display information to be displayed on the display device 20. The priority information is defined per display information and indicates the priority of the display information. The priority indicates the degree of prioritizing display information to be displayed on the display device 20 when the selector 14 has selected plural pieces of display information.

The following describes a case where the selector 14 selects the display information from the storage 13 on the basis of the position log information, the activity log information, and the display condition information listed in FIGS. 3 to 5. The selector 14 selects the display information to be displayed on the display device 20 on the basis of the display condition information and the combination of the position information in the position log information and the activity information in the activity log information. Specifically, the selector 14 specifies one of the combinations of the position information and the activity information in the display condition information. This specified combination corresponds to the combination of the position information included in the position log information and, among the activity information included in the activity log information, the activity information associated with the time corresponding to the position information. The selector 14 then selects the display information corresponding to the specified combination from the display condition information.

When the activity information in the display condition information is related to visit duration indicating the period of stay at the place, the selector 14 specifies the activity information related to the visit duration from the time information and the position information in the position log information.

The selector 14 also creates display candidate information including candidates to be displayed on the display device 20 when plural pieces of display information can be selected.

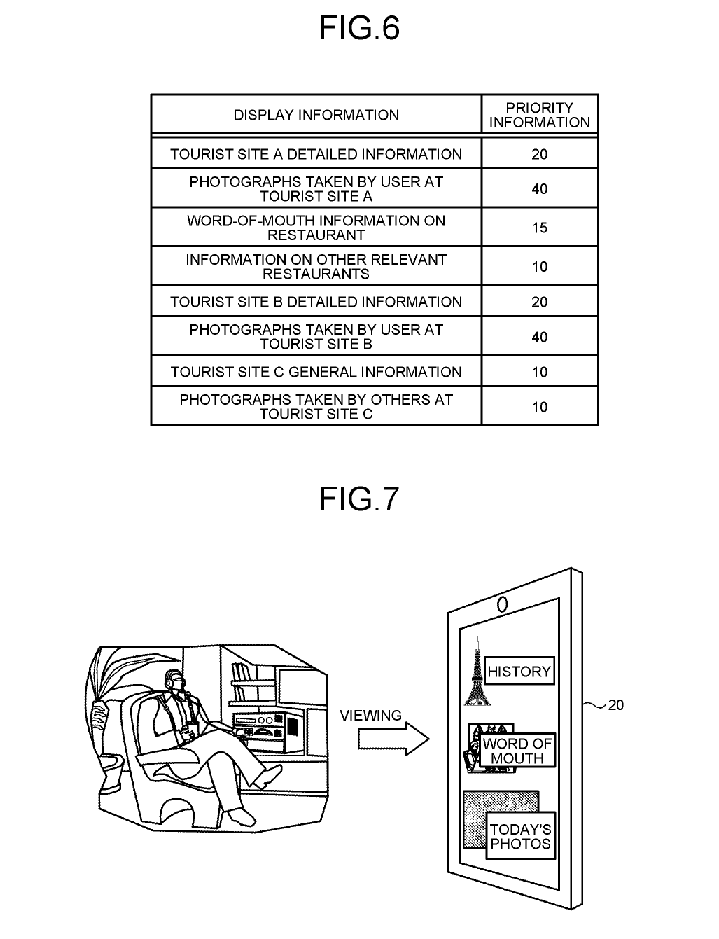

FIG. 6 is a table listing an example of display candidate information of the first embodiment. Here, the display candidate information includes display information and the priority of the display information. The display candidate information in FIG. 6 displays only eight pieces of display information due to space limitation. A method for creating the display candidate information will be described by taking TOURIST SITE B DETAILED INFORMATION and PHOTOGRAPHS TAKEN BY USER AT TOURIST SITE B in the display candidate information in FIG. 6 as an example.

TOURIST SITE B DETAILED INFORMATION will be described. The selector 14 estimates from the time information and the position information in the position log information in FIG. 3 that the user had been at the tourist site B from 13:00, Jun. 8, 2013 to 16:00, Jun. 8, 2013. The selector 14 then estimates that the visit duration at the tourist site B is three hours and thus specifies that the user had stayed at the tourist site B for a long period of time. In other words, the selector 14 specifies that the activity information of the user is STAYING (LONG DURATION). The selector 14 then refers to the display condition information in FIG. 5. The selector 14 confirms that the position information in the position log information is TOURIST SITE and the activity information is STAYING (LONG DURATION). The selector 14 thus selects TOURIST SITE DETAILED INFORMATION as the display information corresponding to the case where the position information in the display condition information is TOURIST SITE and the activity information in the display condition information is STAYING (LONG DURATION) (the combination of TOURIST SITE and STAYING (LONG DURATION)) and selects its priority “20”.

PHOTOGRAPHS TAKEN BY USER AT TOURIST SITE B will be described as an example. The selector 14 estimates from the time information and the position information in the position log information in FIG. 3 that the user had been at the tourist site B from 13:00, Jun. 8, 2013 to 16:00, Jun. 8, 2013. The selector 14 also specifies that the user started a camera application at 14:30, Jun. 8, 2013, from the time information and the position information in the activity log information in FIG. 4. In other words, the selector 14 specifies that the user started the camera application while staying at the tourist site B. The selector 14 then referrers to the display condition information in FIG. 5. The selector 14 confirms that the position information in the position log information is TOURIST SITE and the activity information in the activity log information is TAKING PHOTOGRAPHS. The selector 14 thus selects PHOTOGRAPHS TAKEN BY USER as the display information corresponding to the case where the position information in the display condition information is TOURIST SITE and the activity information in the display condition information is TAKING PHOTOGRAPHS (the combination of TOURIST SITE and TAKING PHOTOGRAPHS) and selects its priority “40”.

Referring back to FIG. 1, the selector 14 transmits the selected display information to the controller 15. When selecting plural pieces of display information, the selector 14 selects at least one piece of display information that can be displayed on the display device 20 at once, from the display candidate information in descending order of priority, based on the priority of the display candidate information. The selector 14 may also select one of the display information of the highest priority or select a certain number of pieces of display information in descending order of priority, based on the priority of the display candidate information. The number of pieces of display information that can be displayed on the display device 20 at once may be set to be changed as appropriate by the user.

The selector 14 selects display information such as TOURIST SITE DETAILED INFORMATION and WORD-OF-MOUTH INFORMATION ON RESTAURANT. However, when the display information does not exist in the storage 13, the display control unit 10 acquires the display information from the Internet 40.

The controller 15 controls to display the display information received from the selector 14 on the display device 20. FIG. 7 is a diagram illustrating a display example on the display device 20 of the first embodiment. FIG. 7 is an example of a case where the display device 20 displays history (tourist site detailed information), word of mouth (word-of-mouth information on restaurants), and today's photos (photographs taken by the user).

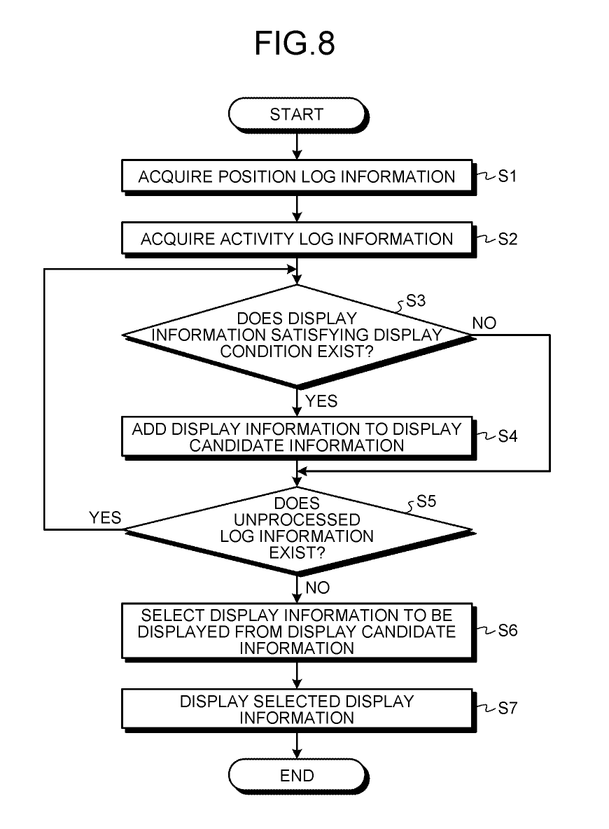

FIG. 8 is a flowchart illustrating an example of a display control method of the first embodiment. The acquisition unit 12 acquires the position log information from the terminal 30 (Step S1). The acquisition unit 12 then acquires the activity log information from the terminal 30 (Step S2). The selector 14 then determines whether the display information to be displayed on the display device 20 exists based on the display condition information and the combination of the position information in the position log information and the activity information in the activity log information (Step S3). If the display information to be displayed on the display device 20 exists (Yes at Step S3), the display information and its priority are added to the display candidate information (Step S4). If identical display information has already been added to the display candidate information, the priority of the display information is added to further increase the priority of the display information. If the display information to be displayed on the display device 20 does not exist (No at Step S3), the system goes to Step S5.

The selector 14 determines whether the combination of the position information in the position log information and the activity information in the activity log information exists on which the determination of display information to be displayed on the display device 20 is unprocessed (Step S5). If the unprocessed combination exists (Yes at Step S5), the system returns to Step S3. If no unprocessed combination exists (No at Step S5), the display information to be displayed is selected from the display candidate information in descending order of priority, based on the priority of the display candidate information (Step S6). The controller 15 then controls to display the display information selected at Step S6 on the display device 20 (Step S7).

In the display control device 10 of the present embodiment, the selector 14 selects the display information based on the position information and the activity information. The display control device 10 thus allows the display device 20 to display the display information in which the user is interested even when the user specifies no display information in advance.

The following elaborates on the activity information indicating user activity. The user activity includes various types of patterns, for example, walking, stopping, sitting, lying, having a meal, picking up merchandise, taking a photograph, listening to music, and browsing or searching for a web site. The present embodiment describes a method for specifying the user activity from the log of the applications of the terminal 30, but the method using the application log information is not limiting. Any method for specifying the user activity may be used.

Activity performed without applications installed in the terminal 30, such as walking, stopping, sitting, lying, having a meal, and picking up merchandise can also be acquired by known activity recognition techniques, for example. A technique with GPS and an acceleration sensor is known to identify walking, running, stopping, or riding in a vehicle or the like outdoors, for example. A technique is also known to specify activity such as having a meal and sleeping from signal patterns acquired by using a microphone or a plurality of sensors such as a pulse wave sensor, for example. A technique is also known to recognize a user by known human detection technology and facial recognition technology using images taken by cameras installed in public spaces and to specify user activity by known activity recognition techniques using the images, for example.

The user activity with the terminal 30 can also be specified in more detail by collecting the load and save histories of content, a web site browsing log, and the like in the terminal 30 while collecting the activity log information using the log of the applications of the terminal 30.

Modification of First Embodiment

A modification of the first embodiment will now be described. The display control device 10 of the modification of the first embodiment specifies user activity not only from histories (position log information and activity log information) but also from information indicating a user's schedule. The information indicating a user's schedule (called “activity schedule information”, hereinafter) is, for example, information on an application for managing a schedule, installed in the terminal 30. The acquisition unit 12 further receives the activity schedule information in addition to the position log information and the activity log information from the terminal 30. The selector 14 selects display information based on, besides the position log information and the activity log information, the activity schedule information. For example, the selector 14 selects display information including information indicating the weather of a travel destination in view of information indicating the schedule for the travel (information such as dates and times and places) in the activity schedule information. The display control device 10 acquires the information from the Internet 40 when the storage 13 contains no information indicating the weather of the travel destination.

The selector 14 of the display control device 10 in the present modification selects the display information based on the position information, the activity information, and the activity schedule information, and thus acquires not only information about past user activity but also information about future scheduled activity of the user. This allows the display control device 10 in the present modification to select display information in which the user has a high interest on the basis of the user's schedule.

### Second Embodiment

The display control device 10 of the second embodiment will now be described. The display control device 10 of the second embodiment differs from the configuration of the display control device 10 of the first embodiment in further including a place recognition unit 16 and a state recognition unit 17. Descriptions of the present embodiment that are the same as that of the first embodiment are omitted.

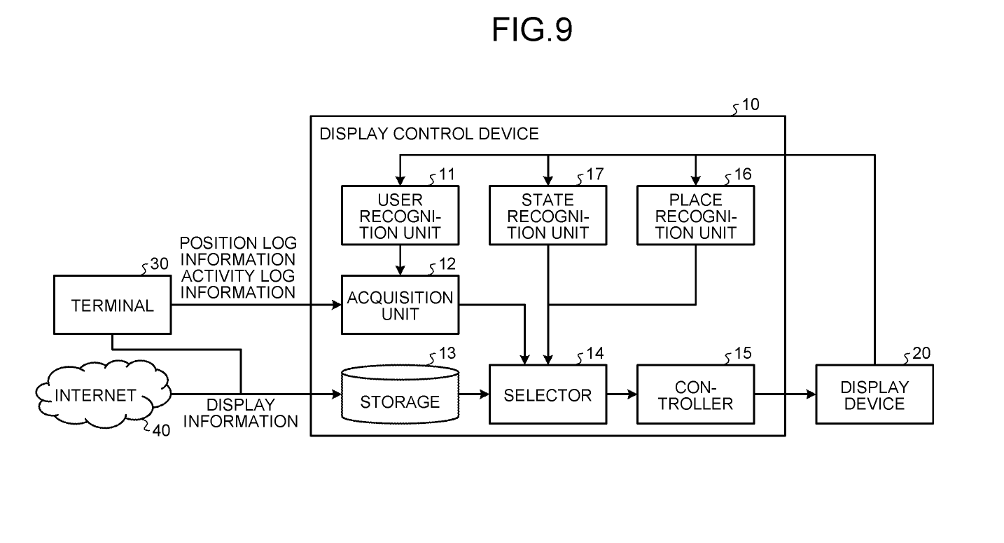

FIG. 9 is a block diagram illustrating an example of the display control device 10 according to the second embodiment. The display control device 10 in the present embodiment includes the user recognition unit 11, the acquisition unit 12, the storage 13, the selector 14, the controller 15, the place recognition unit 16, and the state recognition unit 17. The description of the user recognition unit 11, the acquisition unit 12, the storage 13, and the controller 15 is the same as the description in the first embodiment and is therefore omitted. The selector 14 will be described later.

The place recognition unit 16 receives a static image or a picture taken by the camera 21 and recognizes the installation place of the display device 20 from the static image or the picture. The place recognition unit 16 then determines place information indicating the recognized place. The place information indicates, for example, the type of room such as a living room, a kitchen, a lavatory, and an entrance hall. A method for determining the place information of the display device 20 can include various types of known environment estimation techniques, for example, a method including recognizing the wall pattern of the room and the type of surrounding objects by taking the static image or the picture of the surroundings of the display device 20 by the camera 21, and estimating the place information on the basis of the recognition. For example, the place recognition unit 16 determines the place information as KITCHEN when the installation place of the recognized display device 20 is a kitchen.

The state recognition unit 17 receives the static image or the picture taken by the camera 21 and recognizes the state of the user in the capture range of the camera 21 of the display device 20, from the static image or the picture. The state recognition unit 17 then determines state information indicating the recognized user state. The state information indicates, for example, a user state such as SITTING STATE, WORKING STATE, or LYING STATE. A method for determining the user state can employ, for example, a posture recognition technique to specify the posture of a person by extracting the person from an image taken by the camera 21 and comparing the person to model data corresponding to postures of persons stored in advance. WORKING STATE can be recognized by, for example, obtaining interframe differences from time-series images taken by the camera 21 to detect an active area.

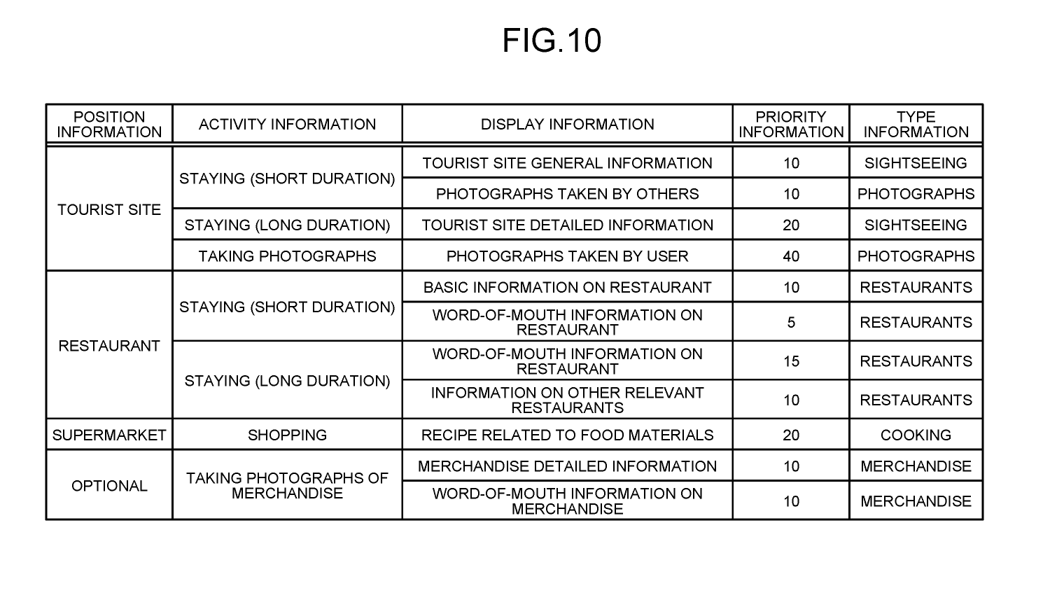

FIG. 10 is a table listing an example of display condition information of the second embodiment. The display condition information of the present embodiment differs from that of the first embodiment in that types are associated with respective pieces of display information. For example, the type of TOURIST SITE DETAILED INFORMATION is SIGHTSEEING, and the type of BASIC INFORMATION ON RESTAURANT is RESTAURANTS.

Referring back to FIG. 9, the selector 14 receives the position log information and the activity log information from the acquisition unit 12, the place information from the place recognition unit 16, and the state information from the state recognition unit 17. The selector 14 of the present embodiment determines the type of the display information in the display condition information of which priority is to be changed based on the place information and the state information. The selector 14 then changes the priority of the display information of the type that is determined to be changed based on priority change information.

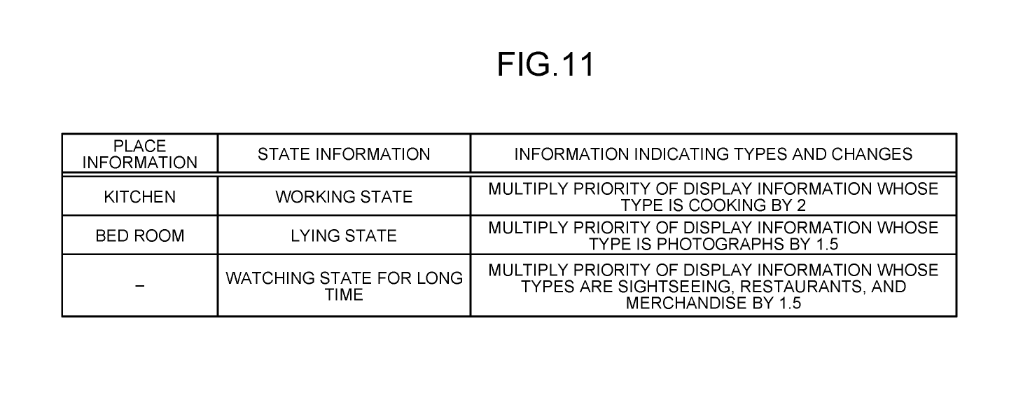

FIG. 11 is a table listing an example of the priority change information of the second embodiment. The priority change information includes place information indicating places, state information indicating states, and information indicating types and changes. This place information corresponds to the place information determined by the place recognition unit 16. The state information corresponds to the state information determined by the state recognition unit 17. The information indicating type and changes indicates the type of the display information of which priority in the display condition information is to be changed and the change in the priority of the display information of the type. The priority change information is information in which the combinations of the place information and the state information are associated with the information indicating type and changes. In other words, the priority change information is information for determining the type of the display information of which the priority information in the display condition information is to be changed and the changes in the priority information, from the combination of the place information and the state information.

Referring back to FIG. 9, the selector 14 searches for the combination of the place information and the state information in the priority change information corresponding to the combination of the place information recognized by the place recognition unit 16 and the state information recognized by the state recognition unit 17. The selector 14 then acquires information indicating type and changes in the priority change information corresponding to the searched combination of the place information and the state information in the priority change information. The selector 14 uses the acquired information indicating type and changes in the priority change information to change the priority information of the display information in the type that is subject to change in priority information. In the priority change information in FIG. 11, for example, when the place information is BED ROOM and the state information of the user is LYING STATE, the priority of the display information of which the type is PHOTOGRAPHS is multiplied by 1.5.

The selector 14 may also determine the type of the display information of which priority is to be changed based on either the place information or the state information. For example, in the priority change information in FIG. 11, when the state information of the user is WATCHING STATE FOR LONG TIME, the priority of the display information of which the types are SIGHTSEEING, RESTAURANTS, and MERCHANDISE is multiplied by 1.5 independent of the place information.

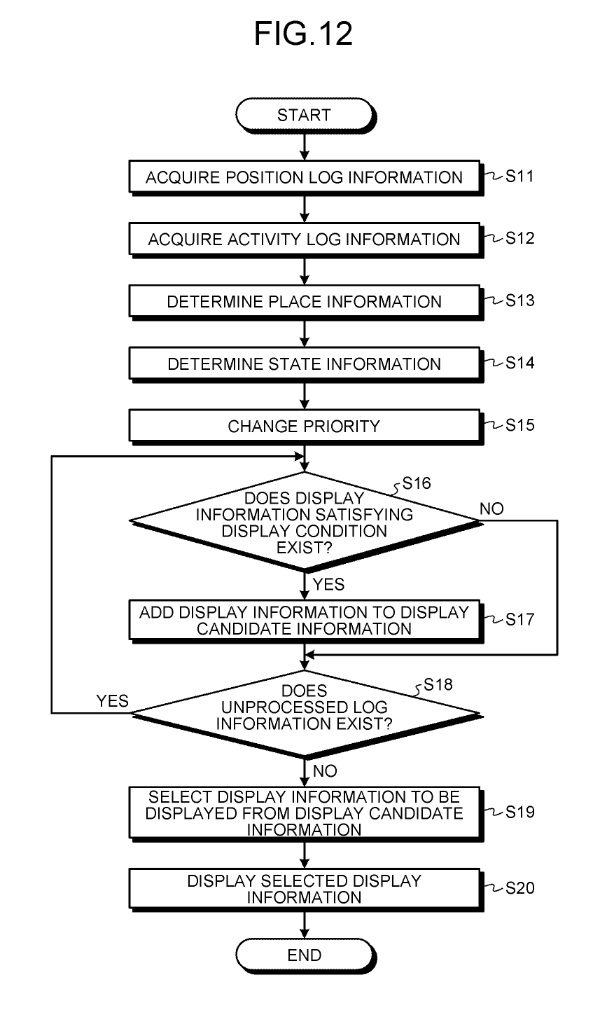

FIG. 12 is a flowchart illustrating an example of the display control method of the second embodiment. Step S11 and Step S12 are the same as Step S1 and Step S2 in FIG. 8 and thus descriptions thereof are omitted. The place recognition unit 16 determines place information (Step S13). The state recognition unit 17 then determines state information (Step S14). The selector 14 changes the priority of the display information in the display condition information based on the place information, the state information, and the priority change information (Step S15). Step S16 to Step S20 are the same as Step S3 to Step S7 in FIG. 8 and thus descriptions thereof are omitted.

The display control device 10 in the present embodiment selects the display information to be displayed on the display device 20 in further consideration of the place information and the state information. This allows the display control device 10 in the present embodiment to select the display information more appropriately than the display control device 10 in the first embodiment, depending on the installation environment of the display device 20 and the user state.

The following elaborates on the selection example of the appropriate display information. For example, when a user watches the display device 20 while cooking in a kitchen, it is considered to be useful for the user to allow the display device 20 to preferentially display the recipe on the Internet 40 or information on purchased food materials checked by the user using a browser application in the terminal 30 when the user was out. The selector 14 of the display control device 10 in the present embodiment increases the priority of the display information of which the type is COOKING in the display condition information when the place information is KITCHEN and the state information is WORKING STATE.

It is also conceivable that even when a user watches the display device 20 in a living room, information to be displayed is changed depending on the user state, for example. When a user watches the display device 20 while sitting on a sofa, for example, the user is thought to watch the content on the display device 20 relatively intensely. It is then conceivable to display, for example, detailed information on the tourist site visited by the user. The selector 14 of the display control device 10 in the present embodiment thus increases the priority of the display information of which the type is SIGHTSEEING in the display condition information when the place information is LIVING ROOM and the state information is SITTING STATE.

In contrast, even when a user watches the display device 20 in a living room, if the user watches the display device 20 while lying, the display device 20 displays content such as photographs taken when going out that can be enjoyed without much concentration on the display 22 so that the user is in a more comfortable fashion. The selector 14 of the display control device 10 in the present embodiment increases the priority of the display information of which the type is PHOTOGRAPHS in the display condition information when the place information is LIVING ROOM and the state information is LYING STATE.

As described above, according to the first and the second embodiments, the display device 20 is allowed to display the display information in which the user has an interest even when the user specifies no display information in advance.

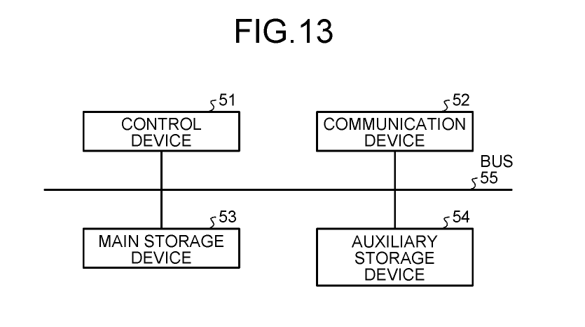

Finally, the following describes the main hardware configuration of each of the display control devices 10 of the first and the second embodiments. FIG. 13 is a block diagram illustrating an example of the main part of the hardware configuration of each display control device 10 of the first and the second embodiments. Each display control device 10 of the first and the second embodiments includes a control device 51, a communication device 52, a main storage device 53, and an auxiliary storage device 54. The control device 51, the communication device 52, the main storage device 53, and the auxiliary storage device 54 are connected with each other through a bus 55.

The control device 51 executes a computer program read from the auxiliary storage device 54 to the main storage device 53. The main storage device 53 is a memory such as a read only memory (ROM) and a random access memory (RAM). The auxiliary storage device 54 is, for example, a hard disk. The communication device 52 is an interface that connects to a network.

The computer program executed by the display control devices 10 of the first and the second embodiments may also be provided as a computer program product by recording the program in a recording medium readable by a computer, such as a compact disc-read-only memory (CD-ROM), a memory card, a CD recordable (CD-R), and a digital versatile disc (DVD) in an installable or executable file format. The computer program executed by the display control devices 10 of the first and the second embodiments may also be provided by storing it in a computer connected to a network such as the Internet and downloading it through the network. The computer program executed by the display control devices 10 of the first and the second embodiments may also be provided or distributed through a network such as the Internet without downloading it. The computer program executed by the display control devices 10 of the first and the second embodiments may also be provided by pre-installing it in a ROM or the like in the display control device 10.

The computer program executed by the display control devices 10 of the first and the second embodiments has a module configuration including functional blocks (the user recognition unit 11, the acquisition unit 12, the selector 14, the controller 15, the place recognition unit 16, and the state recognition unit 17) executable also as a computer program, among functional blocks of the display control device 10 described above.

In an actual hardware, the control device 51 reads a computer program from the recording medium and executes it, and then, each of the modules is loaded on the main storage device 53. Specifically, each module is generated in the main storage device 53. A part or all of the functional blocks of each display control device 10 of the first and the second embodiments may also be implemented by hardware such as an integrated circuit (IC) without implementing it by a computer program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display control device comprising:
an acquisition unit configured to acquire position log information and activity log information, the position log information including pieces of position information that each indicate a position of a user and pieces of first time information that each indicate the time when the piece of position information is detected, the activity log information including pieces of activity information that each indicate activity of the user and pieces of second time information that each indicate the time when the corresponding piece of activity information is detected;
a selector configured to
acquire display condition information in which combinations of the pieces of position information and the pieces of activity information are associated with pieces of display information to be displayed on a display device, respectively,
specify a combination of a piece of position information included in the position log information and a piece of activity information associated with the time corresponding to the piece of position information in the activity log information, from among the combinations of the pieces of position information and the pieces of activity information in the display condition information, and
select the piece of display information corresponding to the specified combination; and
a controller configured to control to display the selected piece of display information on the display device.

2. The device according to claim 1, further comprising a user recognition unit configured to recognize the user, wherein
the acquisition unit is configured to acquire the position log information and the activity log information of the user recognized by the user recognition unit.

3. The device according to claim 1, wherein
the display condition information includes pieces of priority information that indicate priority on display of the respective pieces of display information, and
the selector is configured to, when selecting plural pieces of display information, select at least one piece of display information from the selected pieces of display information in descending order of priority based on the corresponding pieces of priority information.

4. The device according to claim 3, further comprising:
a place recognition unit configured to recognize a place of the display device that displays the piece of display information and determine a piece of place information that indicates the recognized place; and
a state recognition unit configured to recognize a state of the user and determine a piece of state information that indicates the recognized state of the user, wherein
the display condition information includes pieces of type information that indicate types of the respective pieces of display information,
the selector is configured to
further acquire priority change information in which a combination of the piece of place information and the piece of state information is associated with information that indicates the piece of type information of the piece of display information of which the piece of priority information is to be changed and a change in the piece of priority information, and
further select, when changing the piece of priority information based on the priority change information and selecting plural pieces of display information, at least one piece of display information from the selected pieces of the display information in descending order of priority based on the changed piece of priority information.

5. The device according to claim 1, wherein the activity log information includes a usage log of an application in a terminal used by the user.

6. The device according to claim 1, wherein
the acquisition unit is configured to further acquire activity schedule information that indicates a schedule of activity of the user from an application in a terminal used by the user, and
the selector is configured to further select the piece of display information based on the activity schedule information.

7. The device according to claim 1, further comprising a storage configured to store therein the display condition information.

8. A display control method comprising:
acquiring position log information and activity log information, the position log information including pieces of position information that each indicate a position of a user and pieces of first time information that each indicate the time when the piece of position information is detected, the activity log information including pieces of activity information that each indicate activity of the user and pieces of second time information that each indicate the time when the corresponding piece of activity information is detected;
acquiring display condition information in which combinations of the pieces of position information and the pieces of activity information are associated with pieces of display information to be displayed on a display device, respectively;
specifying a combination of a piece of position information included in the position log information and a piece of activity information associated with the time corresponding to the piece of position information in the activity log information, from among the combinations of the pieces of position information and the pieces of activity information in the display condition information;
selecting the piece of display information corresponding to the specified combination; and
controlling to display the selected piece of display information on the display device.

9. A computer program product comprising a computer-readable medium containing a program executed by a computer, the program causing the computer to execute:
acquiring position log information and activity log information, the position log information including pieces of position information that each indicate a position of a user and pieces of first time information that each indicate the time when the piece of position information is detected, the activity log information including pieces of activity information that each indicate activity of the user and pieces of second time information that each indicate the time when the corresponding piece of activity information is detected;
acquiring display condition information in which combinations of the pieces of position information and the pieces of activity information are associated with pieces of display information to be displayed on a display device, respectively;
specifying a combination of a piece of position information included in the position log information and a piece of activity information associated with the time corresponding to the piece of position information in the activity log information, from among the combinations of the pieces of position information and the pieces of activity information in the display condition information;
selecting the piece of display information corresponding to the specified combination; and
controlling to display the selected piece of display information on the display device.
